(19) United States
(12) Patent Application Publication
(10) Pub. No.: US 2012/0063532 A1
(43) Pub. Date: Mar. 15, 2012

(54) RECEPTION DEVICE, RECEIVING METHOD, COMMUNICATION SYSTEM, AND COMMUNICATION METHOD

(76) Inventors: Takashi Yoshimoto, Osaka (JP); Ryota Yamada, Osaka (JP); Katsuya Kato, Osaka (JP)

(21) Appl. No.: 13/322,034

(22) PCT Filed: Apr. 15, 2010
(86) PCT No.: PCT/JP2010/002754

§ 371 Date: Nov. 22, 2011

(30) Foreign Application Priority Data
May 28, 2009 (JP) 2009 128748

(51) Int. Cl. H04B 1/10; H04B 15/00

(52) U.S. Cl. 375/285; 375/350

(57) ABSTRACT

The filtering unit (203) is configured to perform a filtering process in a time domain so as to reduce a signal element of a non-desired user from a received signal. The interference canceller (205) is configured to cancel, from the signal having been subjected to the filtering process, an interference element generated using a result of a decoding process performed on the signal having been subjected to the filtering process, and outputs a result thereof. A signal detector (209) is configured to perform a decoding process on the signal output from the interference canceller and to output a result of the decoding process.

### TECHNICAL FIELD

The present invention relates to a reception device, a receiving method, a communication system, and a communication method.

Priority is claimed on Japanese Patent Application No. 2009-128748, filed May 28, 2009, the content of which is incorporated herein by reference.

### BACKGROUND ART

Regarding a wireless communication system, for example, a transmission method using OFDM (Orthogonal Frequency Division Multiplexing) enables, by multi-carrier conversion and insertion of a guard interval, a reduction in effects of multi-path fading caused by high-speed digital signal transmission. Regarding the OFDM, if there is a delayed wave exceeding a guard interval length, however, a previous symbol is included in an FFT (Fast Fourier Transform) section, thereby causing inter-symbol interference (ISI). Additionally, a boundary between two adjacent symbols, that is, a discontinuous section of a signal is included in the FFT section, thereby causing inter-carrier interference (ICI). Thus, the inter-symbol interference and the inter-carrier interference cause deterioration of characteristics.

FIG. 14 is a diagram illustrating signals transmitted from a transmission device to a reception device through multi-path environments. In FIG. 14, a horizontal axis denotes a time. An OFDM symbol includes: an effective symbol; and a guard interval which is a copy of a last part of the effective symbol and added in front of the effective symbol.

If an FFT process is performed with respect to a section t4 in synchronization with a preceding wave (first arrival wave) s1, it is shown that a delayed time t1 of a delayed wave s2 is included in the guard interval. It is shown that delay times t2 and t3 of delayed waves s3 and s4 exceed the guard interval. The preceding wave and the delayed waves are also referred to as arrival waves. A hatched portion denotes an element of an OFDM symbol before a desired OFDM symbol.

Regarding the delayed waves s3 and s4, as shown in the hatched portions before the delayed waves s3 and s4, an OFDM symbol preceding the desired OFDM symbol is partially included in the FFT section for the desired OFDM symbol, thereby causing inter-symbol interference (ISI). Regarding the delayed wave s3, a boundary between the desired OFDM symbol and an OFDM symbol preceding the OFDM symbol is included in the section t4, thereby causing inter-carrier interference (ICI). Regarding the delayed wave s4, similarly, a boundary between the desired OFDM symbol and an OFDM symbol preceding the OFDM symbol is included in the section t4, thereby causing inter-carrier interference.

One of methods of improving the deterioration of the characteristics caused by the inter-symbol interference and the inter-carrier interference is proposed in Patent Document 1 below. In this background art, a reception device performs a demodulation operation once. Then, the reception device generates, with use of the result of error correction (output of an MAP (Maximum A posteriori Probability) decoder), replica signals (interference replica signals) of subcarriers including elements of the inter-symbol interference and the inter-carrier interference, which are other than a desired subcarrier. Then, the reception device iteratively performs, on the reception signal from which the replica signals are subtracted, a signal equalization process based on MMSE (Minimum Mean Square Error) standard and another demodulation operation, thereby improving the deterioration of the characteristics caused by the inter-symbol interference and the inter-carrier interference. Such a technology of iteratively performing the interference cancelling process, the equalization process, and the decoding process while using the results of soft decision, is referred to as turbo equalization.

By the way, as a multiple access method using the OFDM for wireless communication systems, there is OFDMA (Orthogonal Frequency Division Multiple Access) (see, for example, Non-Patent Document 1). FIG. 15 illustrates an example of the OFDMA in which two users are assigned to a set of orthogonalized subcarriers. Among 12 subcarriers, the left 6 subcarriers are occupied by a user 1, and the remaining 6 subcarriers are occupied by a user 2. The subcarriers occupied by each user are allocated with respective data modulation symbols to be transmitted by the user. In the case of the OFDMA, if a delayed wave exceeding the guard interval length is present, the inter-symbol interference and the inter-carrier interference occur, thereby causing deterioration of transmission characteristics for each user.

### CITATION LIST

### Patent Document

[Patent Document 1] Japanese Patent Unexamined Application, First Publication No. 2004-221702

### [Non-Patent Document]

[Non-Patent Document 1] “3rd Generation Partnership Project; Technical Specification Group Radio Access Network; Evolved Universal Terrestrial Radio Access (E-UTRA); Physical Channels and Modulation (Release 8)” 3GPP TS 36.211 V8.3.0, May 2008.

### DISCLOSURE OF THE INVENTION

### Problems to be Solved by the Invention

When the reception device receiving an OFDMA signal performs a turbo equalization process, the reception device needs the results of error correction decoding performed by another user. For example, when the reception device of the user 1 receives the OFDMA signal in which the two users are assigned to the orthogonalized subcarriers as shown in FIG. 15, it is necessary to decode a signal of the user 2 which is other than the desired signal, and then generate modulation symbols of the user 2 from the result of the decoding, in order to generate ISI replicas. For the user 1 to perform the decoding process and the generation of modulation symbols with respect to the user 2, it is necessary for the reception device of the user 1 to know control information required for performing a demodulation process and the decoding process, such as MCS (Modulation and Coding Scheme) of the user 2. However, the confidentiality of each of the users 1 and 2 is protected based on the unique user ID. For this reason, each user cannot know the MCS of the other user, and therefore sufficient improvement of the characteristics cannot be expected. If one user reports the MCS of the other user and performs error correction decoding for the other user, the number of control signals increases, thereby decreasing the utilization efficiency.

The present invention is made in view of the above problems. An object of the present invention is to provide a reception device and a receiving method, which can cancel the inter-symbol interference and the inter-carrier interference, thereby improving the transmission characteristics.

### Means for Solving the Problems

To solve the above problems, a reception device according to the present invention is configured to receive a signal in which a plurality of users are multiplexed using a plurality of orthogonalized frequencies, and perform a filtering process in a time domain so as to reduce a signal element for a non-desired user from the signal received.

Additionally, the reception device includes: a receiver configured to receive the signal in which the plurality of users are multiplexed using the plurality of orthogonalized frequencies; a filtering unit configured to perform the filtering process in the time domain so as to reduce the signal element for the non-desired user from the signal received by the receiver; an interference canceller configured to cancel, from the signal having been subjected to the filtering process, an interference element generated using a result of a decoding process performed on the signal having been subjected to the filtering process by the filtering unit; a signal detector configured to perform a decoding process on the signal output from the interference canceller and outputs a result of the decoding process. The process performed by the interference canceller and the process performed by the signal detector are iteratively performed until a predetermined condition is satisfied. The interference canceller is configured to output, for a first time of the iteration, one of the signal having been subjected to the filtering process and the signal received by the receiver without generating and cancelling the interference element. The interference canceller is configured to generate, for a second time or more, an interference element using a result of the decoding process for the previous time.

Additionally, the reception device further includes a control signal detector configured to detect, from a control signal included in the signal received by the receiver, a position of a subcarrier to which a data signal of a desired user is mapped.

Additionally, the interference canceller is configured to perform an interference cancelling process based on the position of the subcarrier.

Additionally, the filtering unit is configured to set a band for the filtering process based on the position of the subcarrier.

Additionally, the signal detector is configured to perform an error correction decoding process and output a soft decision value. The reception device further includes: a replica generator configured to generate an interference replica using the soft decision value output from the signal detector; and a subtractor configured to subtract the interference replica from the signal having been subjected to the filtering process by the filtering unit.

Additionally, a receiving method of the present invention includes: a first step of receiving a signal in which a plurality of users are multiplexed using a plurality of orthogonalized frequencies; a second step of performing a filtering process in a time domain so as to reduce a signal element for a non-desired user from the signal received in the first step; a third step of cancelling, from the signal having been subjected to the filtering process, an interference element generated using a result of a decoding process performed on the signal having been subjected to the filtering process by the filtering unit; and a fourth step of performing a decoding process on the signal output from the interference canceller and outputting a result of the decoding process. The process in the third step and the process in the fourth step are iteratively performed until a predetermined condition is satisfied. The third step includes: outputting, for a first time of the iteration, one of the signal having been subjected to the filtering process and the signal received by the receiver without generating and cancelling the interference element; and generating, for a second time or more, an interference element using a result of the decoding process for the previous time.

Additionally, a communication system includes: a transmission device configured to transmit a signal in which a plurality of users are multiplexed using a plurality of orthogonalized frequencies; and a reception device configured to receive and decode the signal transmitted from the transmission device. The reception device includes: a receiver configured to receive the signal transmitted; a filtering unit configured to perform a filtering process in a time domain so as to reduce a signal element for a non-desired user from the signal received by the receiver; an interference canceller configured to cancel, from the signal having been subjected to the filtering process, an interference element generated using a result of a decoding process performed on the signal having been subjected to the filtering process by the filtering unit; and a signal detector configured to perform a decoding process on the signal output from the interference canceller and outputs a result of the decoding process. The process performed by the interference canceller and the process performed by the signal detector are iteratively performed until a predetermined condition is satisfied. The interference canceller is configured to output, for a first time of the iteration, one of the signal having been subjected to the filtering process and the signal received by the receiver without generating and cancelling the interference element. The interference canceller is configured to generate, for a second time or more, an interference element using a result of the decoding process for the previous time.

Additionally, a communication method includes: a process of transmitting signal in which a plurality of users are multiplexed using a plurality of orthogonalized frequencies; and a process of receiving and decoding the signal transmitted from the transmission device. The process of receiving and decoding the signal includes: a first step of receiving the signal transmitted; a second step of performing a filtering process in a time domain so as to reduce a signal element for a non-desired user from the signal received in the first step; a third step of cancelling, from the signal having been subjected to the filtering process, an interference element generated using a result of a decoding process performed on the signal having been subjected to the filtering process by the filtering unit; and a fourth step of performing a decoding process on the signal output from the interference canceller and outputting a result of the decoding process. The process in the third step and the process in the fourth step are iteratively performed until a predetermined condition is satisfied. The third step includes: outputting, for a first time of the iteration, one of the signal having been subjected to the filtering process and the signal received by the receiver without generating and cancelling the interference element; and generating, for a second time or more, an interference element using a result of the decoding process for the previous time.

### Effects of the Invention

According to the present invention, the inter-symbol interference and the inter-carrier interference can be cancelled without increasing overhead, such as control signals, thereby improving the transmission characteristics.

### BRIEF DESCRIPTION OF THE DRAWINGS

FIG. 1 is a schematic block diagram illustrating a configuration of a transmission device 100 according to a first embodiment of the present invention.

FIG. 2 is a diagram illustrating an example of mapping modulation symbols of a user n received from a symbol generator 102-n to input points of an IFFT unit 103.

FIG. 3 is a schematic block diagram illustrating a configuration of a reception device 200 according to the first embodiment of the present invention.

FIG. 4 is a diagram illustrating each of subcarrier elements of a signal output from an FFT unit 207.

FIG. 5 is a schematic block diagram illustrating a configuration of an interference canceller 205.

FIG. 6 is a schematic block diagram illustrating a configuration of a replica generator 232.

FIG. 7 is a flowchart illustrating operations of the reception device 200.

FIG. 8 is a schematic block diagram illustrating a configuration of a transmission device 300 according to a second embodiment of the present invention.

FIG. 9 is a diagram illustrating an example of mapping a modulation symbol and a control signal for the user n, which are received from the symbol generator 102-n, to input points of an IFFT unit 303.

FIG. 10 is a schematic block diagram illustrating a configuration of a reception device 400 according to the second embodiment of the present invention.

FIG. 11 is a diagram illustrating output signals of an FFT unit 207 when a process performed by an interference canceller 405 is an initial process.

FIG. 12 is a diagram illustrating output signals of the FFT unit 207 when a process performed by the interference canceller 405 is an iterative process.

FIG. 13 is a flowchart illustrating operations of the reception device 400.

FIG. 14 is a diagram illustrating signals transmitted from a transmission device to a reception device through multi-path environments.

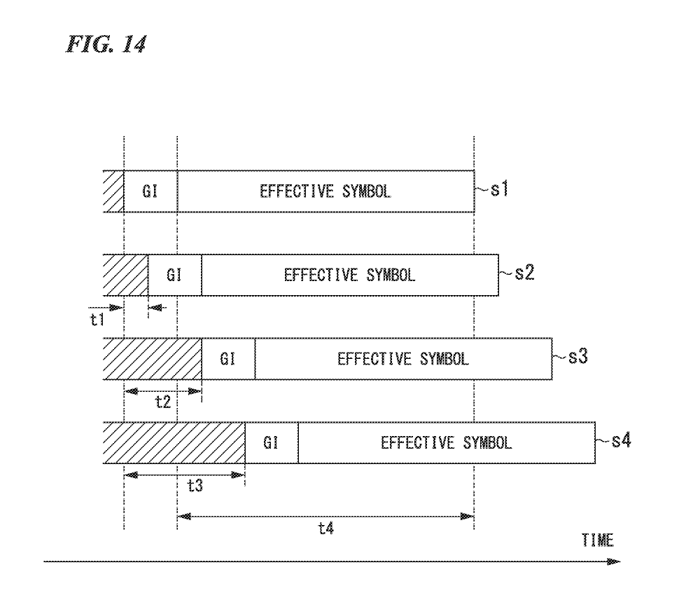

FIG. 15 illustrates an example of OFDMA in which two users are assigned to a set of orthogonal subcarriers.

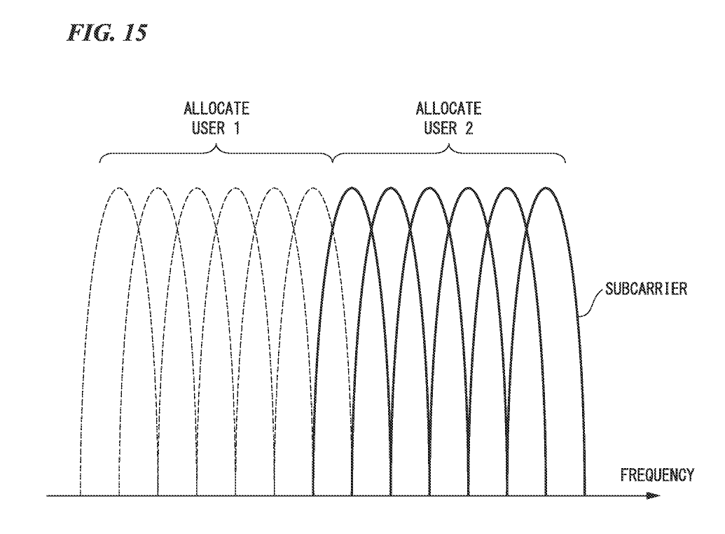

### BEST MODE FOR CARRYING OUT THE INVENTION

Hereinafter, embodiments of the present invention are explained in detail. The embodiments of the present invention are explained with a case in which a transmission device transmits an OFDMA signal that is a signal in which users are multiplexed using orthogonal frequencies.

### First Embodiment

A communication system according to a first embodiment of the present invention includes: a transmission device 100 configured to transmit an OFDMA signal in which multiple users are assigned to OFDM subcarriers; and a reception device 200 configured to receive the signal transmitted from the transmission device 100. For example, the transmission device 100 is installed in a base station for downlink of a mobile communication system. The reception device is installed in a mobile terminal for downlink of the mobile communication system. Hereinafter, explanations are given with a case in which the transmission device 100 is installed in a base station in a cellular system, and the reception device 200 is installed in one of multiple mobile terminals linked to the base station.

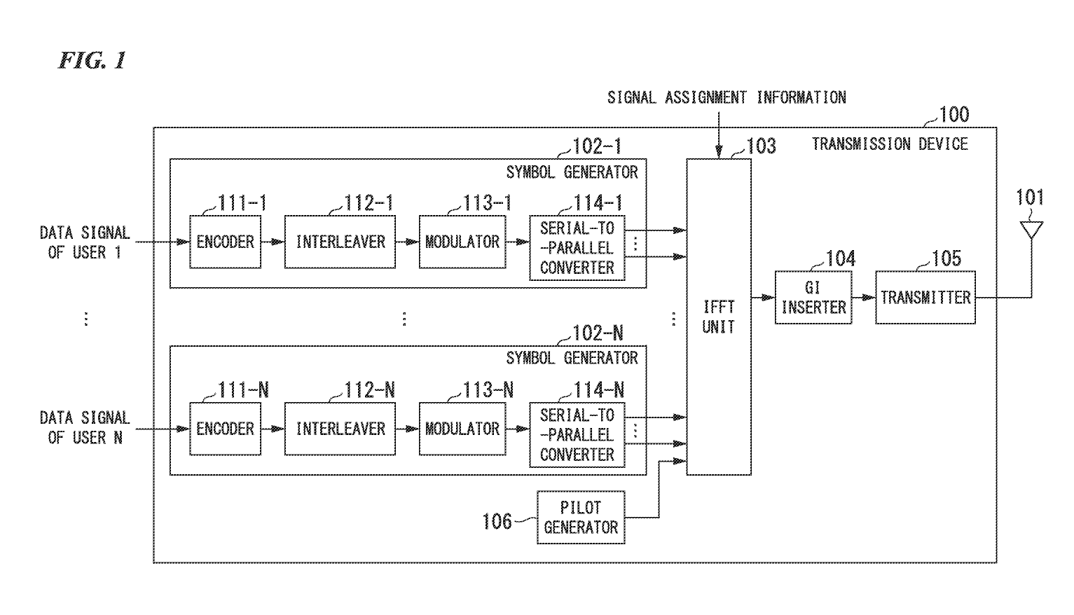

FIG. 1 is a schematic block diagram illustrating a configuration of the transmission device 100 according to the first embodiment of the present invention. The transmission device 100 includes: symbol generators 102-1 to 102-N; an IFFT (Inverse Fast Fourier Transform) unit 103; a GI inserter 104; a transmitter 105; and a pilot generator 106. An antenna unit 101 is connected to the transmitter 105. N denotes the number of users who can be linked to the base station installed with the transmission device 100.

The symbol generator 102-n (n=1, 2, . . . , N) generates a signal to be transmitted from the transmission device 100 of the base station to a user n. The symbol generator 102-n includes: an encoder 111-n; an interleaver 112-n; a modulator 113-n; and a serial-to-parallel converter 114-n.

The symbol generator 102-n receives a data signal to be transmitted to the user n, which is input by a MAC (Media Access Control) unit or the like (which is not shown in FIG. 1, and means a function positioned at an upper layer, such as a MAC layer or a network layer). Hereinafter, the data signal means a signal other than a control signal, and includes not only a data signal used for computer processing, but also an audio signal, an image signal, and another information signal, which have been subjected to compression coding. The encoder 111-n performs, on the input data signal of the user n, an error correction coding process that is any one of a turbo coding, LDPC (Low Density Parity Check), a convolutional coding, and the like. The interleaver 112-n rearranges the order of the encoded data signals of the user n, which are output from the encoder 111-n, in order to prevent burst errors, based on a drop in the reception power caused by frequency selective fading. The modulator 113-n performs, on the encoded data signals of the user n which are output from the interleaver 112-n, data modulation such as BPSK (Binary Phase Shift Keying), QPSK (Quadrature Phase Shift Keying), 16QAM (16 Quadrature Amplitude Modulation), or 64QAM (64 Quadrature Amplitude Modulation), to generate modulation symbols. The serial-to-parallel converter 114-n performs, based on the input standard with respect to the IFFT unit 103, serial-to-parallel conversion on the modulation symbols of the user n which are output from the modulator 113-n.

The pilot generator 106 generates a pilot symbol for the reception device to perform channel estimation. The pilot symbol may be common to each mobile terminal (each user) linked to the base station installed with the transmission device 100, or may be defined for each user. Preferably, a code sequence included in the pilot symbol is an orthogonal sequence, such as a Hadamard code, or a CAZAC (Constant Amplitude Zero Auto-Correlation) sequence.

The IFFT unit 103 maps, to IFFT input points, the modulation symbols and the pilot symbol for the user n which are received from the symbol generator 102-n, based on signal assignment information reported by the MAC unit or the like (not shown), and performs an IFFT process. Thus, the IFFT unit 103 converts each of the symbols from frequency domain signals to a time domain signal.

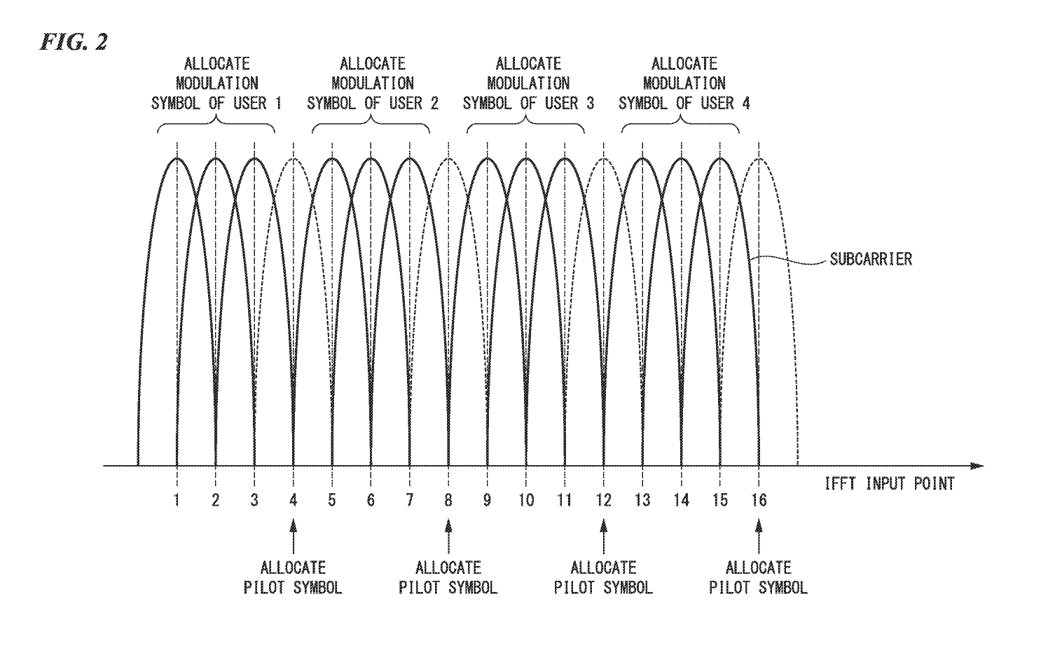

FIG. 2 is a diagram illustrating an example of mapping to input points of the IFFT unit 103, the modulation symbols and the pilot symbol for the user n which are received from the symbol generator 102-n. FIG. 2 shows a case in which the number of IFFT points is 16, the number of users is 4 (N=4), and three OFDMA subcarriers are assigned to each user. Additionally, a pilot symbol is allocated between two adjacent sets of subcarriers to which the respective users are assigned. User assignment information, such as the positions of mapping to the IFFT input points and the number of mapping for each user, is reported by signal assignment information. The positions and the number of mapping, which are reported by the signal assignment information, are determined based on a channel condition between the base station installed with the transmission device 100 and the mobile terminal of each user, and the amount of data to be transmitted from the base station to the mobile terminal of each user. The determination of the positions and the number of mapping for each user is referred to as scheduling. The signal assignment information may be reported to the mobile terminal by the same OFDM symbols and the same frame as those or the user, or by different OFDM symbols and a different frame.

Although the same number of subcarriers are assigned to each user in the case of FIG. 2, the number of subcarriers to be assigned to each user may be different. Additionally, subcarriers to be mapped to each user (positions of IFFT input points) may not be arranged adjacently, and may be scattered. Further, subcarriers to be allocated with pilot symbols may be different for each OFDM symbol and each frame.

Although the data signals and the pilot signals for the users are mapped to OFDMA subcarriers, a control signal for each user may be included.

Referring back to FIG. 1, the GI inserter 104 adds a guard interval (GI) to the time domain signal converted by the IFFT unit 103. For example, the GI inserter 104 copies a last part of the time domain signal (effective symbol) output from the IFFT unit, and adds the last part to the head of the effective symbol. The effective symbol with the GI added is referred to as an OFDM symbol. When a signal output from the GI inserter 104 is denoted as s(t), s(t) can be expression by the following expression (1).

$$\begin{matrix}[ Expression 1 ] & \\ s ( t ) = \frac{1}{\sqrt{{N}_{f}}} {\sum }_{l = - ∞}^{∞} {\sum }_{k = 0}^{{N}_{f} - 1} {c}_{k , l} {e}^{j k {Δ}_{f} ( t - l {T}_{s} )} & ( 1 )\end{matrix}$$

Here, N_{f} denotes the number of IFFT points. c_{k,l} denotes a symbol of the l-th OFDM symbol, which is allocated to the k-th subcarrier. Δ_{f} denotes the subcarrier interval. Tₛ denotes the length of the OFDM symbol (including the GI length). j denotes the imaginary unit. In the case of the user assignment shown in FIG. 2, c_{0,1} to c_{2,1} among c_{k,l} are allocated with the modulation symbols of the user 1 (IFFT input points 1 to 3 shown in FIG. 2). c_{4,1} to c_{6,1} among c_{k,l} are allocated with the modulation symbols of the user 2 (IFFT input points 5 to 7 shown in FIG. 2). c_{8,1} to c_{10,1} among c_{k,l} are allocated with the modulation symbols of the user 3 (IFFT input points 9 to 11 shown in FIG. 2). c_{12,1} to c_{14,1} among c_{k,l} are allocated with the modulation symbols of the user 4 (IFFT input points 13 to 15 shown in FIG. 2). Additionally, pilot symbols are allocated to c_{3,1} (IFFT input point 4 shown in FIG. 2), c_{7,1} (IFFT input point 8 shown in FIG. 2), c_{11,1} (IFFT input point 12 shown in FIG. 2), and c_{15,1} (IFFT input point 16 shown in FIG. 2).

The transmitter 105 converts (digital-to-analog converts) the OFDM symbols output from the GI inserter 104 into an analog signal. Then, the transmitter 105 performs, on the converted analog signal, a filtering process that performs band limitation. Then, the transmitter 105 converts the signal having been subjected to the filtering process into a frequency band signal that can be transmitted, and transmits the frequency band signal through the antenna unit 101. The signal output from the transmission device 100 is referred to as an OFDMA signal.

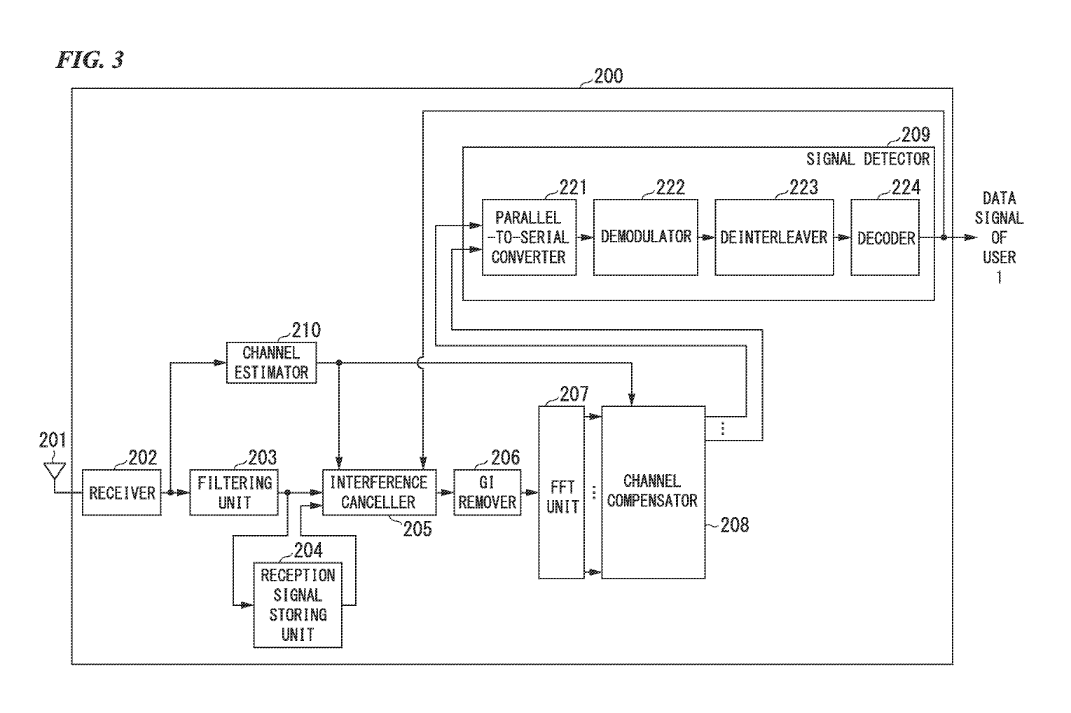

FIG. 3 is a schematic block diagram illustrating a configuration of the reception device 200 according to the first embodiment of the present invention. Explanations are made under the assumption that the reception device 200 is installed in the mobile terminal of the user 1, which receives a signal transmitted from the transmission device 100. It is possible that a reception device installed in the mobile terminal of the user n (n=2, . . . , N) has a similar function.

The reception device 200 includes: a receiver 202; a filtering unit 203; a reception signal storing unit 204; an interference canceller 205; a GI remover 206; an FFT unit 207; a channel compensator 208; a signal detector 209; and a channel estimator 210. An antenna unit 201 is connected to the receiver 202.

In the reception device 200, upon receiving, through the antenna 201, the OFDMA signal transmitted from the transmission device 100, the receiver 202 downconverts the received signal into a frequency band signal that can be subjected to digital signal processing, such as a signal detecting process. Then, the receiver 202 performs a filtering process that removes spurious elements. Then, the receiver 202 converts (analog-to-digital converts) the signal having been subjected to the filtering process, which is an analog signal, into a digital signal. Then, the receiver 202 outputs the digital signal to the filtering unit 203 and the channel estimator 210.

The channel estimator 210 performs channel estimation that estimates a variation in amplitude and phase, which is caused by fading between the transmission device 100 and the reception device 200, and the like. Then, the channel estimator 210 outputs, to the interference canceller 205 and the channel compensator 208, a channel estimation value that is the result of the channel estimation. The channel estimation can be performed by using, for example, a pilot symbol that is a known signal and included in the signal output from the receiver 202. If the OFDMA signal having been subjected to the symbol mapping shown in FIG. 2 is received, subcarrier signals (signal elements corresponding to the IFFT input points of 4, 8, 12, and 16), which are the frequency domain signals converted from the received OFDMA signal and which are allocated with pilot symbols, are used to calculate a frequency response. The frequency response for subcarriers other than the subcarriers allocated with the pilot symbols can be calculated by interpolation technology, such as linear interpolation or FFT interpolation, with use of the frequency response for the subcarriers allocated with the pilot symbols. In the first embodiment, channel estimation is performed by using the signal output from the receiver 202, thereby enabling channel estimation using all the pilot symbols allocated to the same OFDM symbols as the OFDM symbols allocated with data signals of the desired user

Alternatively, the channel estimation can be performed by using part of the pilot symbols allocated to the same OFDM symbols as the OFDM symbols allocated with the data signals of the desired user. Further, the channel estimation can be performed by using OFDM symbols to which data signals of the desired user are not allocated, or the pilot symbols allocated to a frame. Moreover, iterative channel estimation, in which the result of decoding output from the signal detector 209 is used, may be used as the channel estimation.

The filtering unit 203 suppresses, from the signal output from the receiver 202, in the time domain, signal elements of subcarriers allocated with the data signals of non-desired users. In other words, the filtering unit 203 extracts subcarriers including desired data signals (data signals addressed to the reception terminal). In the reception device 200, the filtering unit 203 is a time filter that suppresses frequency elements of subcarriers allocated with data signals other than those of the user 1. In other words, the filtering unit 203 extracts subcarriers including desired data signals (data signals addressed to the reception terminal) by the time filter having a passband covering frequencies associated with the subcarrier numbers k of 1 to 3. As the time filter, an FIR filter (Finite Impulse Response Filter), an IIR filter (Infinite Impulse Response Filter), a matched filter, or the like may be used. In the first embodiment, the reception device 200 is configured to know the positions of subcarriers allocated with the data signals before receiving the data signals of the desired user. For example, before receiving the data signals, the reception device 200 is given notification by the transmission device 100 through the control signal or the like.

The reception signal storing unit 204 stores the signal output from the filtering unit 203. Additionally, the reception signal storing unit 204 outputs the stored signal when the interference canceller 205 performs an iterative interference process.

The interference canceller 205 iteratively performs a process of cancelling interference elements from the signal output from the filtering unit 203 or the reception signal storing unit 204, using the channel estimation values output from the channel compensator 210 and soft decision values that are the results of the decoding output from the signal detector 209. Specifically, using LLRs (Log Likelihood Ratios) of the encoded bits decoded, which are output from the signal detector 209, the interference canceller 205 generates a replica of a signal that the transmission device 100, which is the transmission source of the received signal, might have transmitted to the reception device 200. In other words, the reception device 200 generates a replica of the transmission signal of the user 1, which the transmission device 100 might have transmitted. Additionally, the interference canceller 205 generates an interference replica using the replica of the transmission signal and the channel estimation value received from the channel estimator 210. Then, the interference canceller 205 subtracts the generated interference replica from the signal output from the filtering unit 203 or the reception signal storing unit 204 (the details will be explained later).

The GI remover 206 removes, from the signal from which the replica of the interference elements have been cancelled and which is output from the interference canceller 205, the guard interval section added by the transmission device 100 to prevent distortion due to delayed waves. The FFT unit 207 performs on the signal from which the guard interval section has been removed by the GI remover 206, Fourier transform to convert the time domain signal into frequency domain signals.

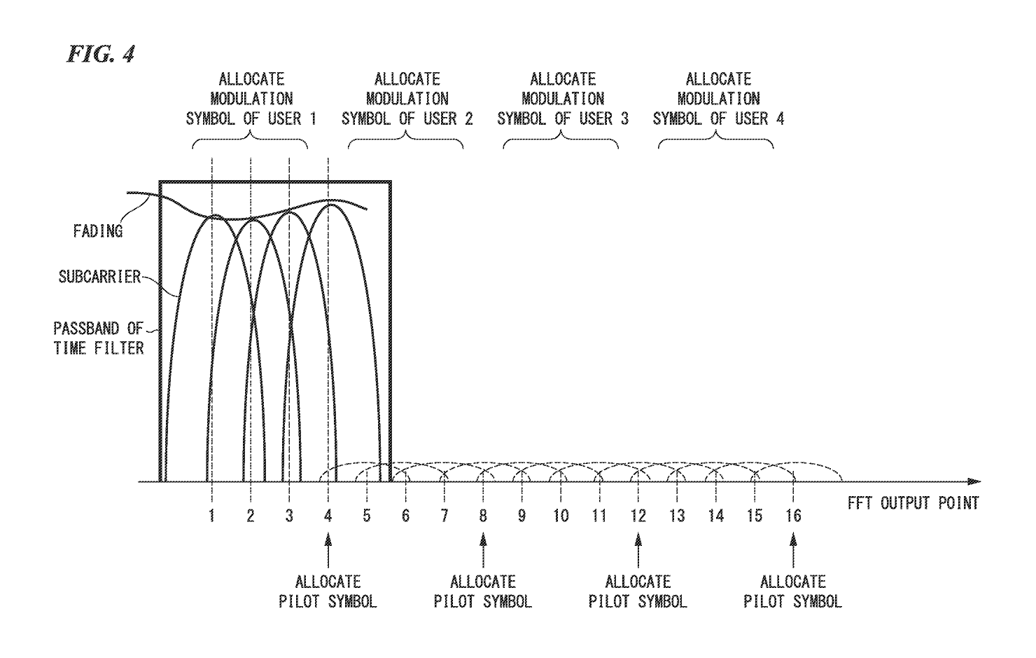

FIG. 4 illustrates each of subcarrier elements of the signals output from the FFT unit 207. FIG. 4 shows a case in which the transmission device 100 performs user assignment shown in FIG. 2. In FIG. 4, output points 1 to 3 of the FFT unit 207 are the positions of subcarriers allocated with data of the user 1 by the transmission device 100. Output points 5 to 16 are the positions of subcarriers allocated to non-desired users (users 2 to 4) or the positions of subcarriers allocated with pilot symbols. The filtering unit 203 suppresses the frequency elements of the subcarrier elements allocated to the non-desired users or the subcarrier elements allocated with the pilot symbols, which are input to the FFT unit 207. Accordingly, occurrence of inter-symbol interference due to the signal elements for the non-desired users can be prevented in the OFDM symbol section for the FFT unit 207 to perform the FFT process. Further, inter-subcarrier interference that the subcarriers allocated to the desired user received from the elements of the subcarriers allocated to the non-desired users can be reduced. In the first embodiment, the band of the FFT output points 1 to 4 including the positions of the subcarriers allocated with the pilot symbols (FFT output point 4 of the FFT unit 207) is set to the passband of the filtering unit 203. Then, interference that the subcarrier element corresponding to the FFT output point 4 gives to the elements of the subcarriers allocated to the desired user (FFT output points 1 to 3) are cancelled by the iterative process performed by the interference canceller 205 using the replica of the transmission signal including the known pilot symbol. Alternatively, the band of the FFT output points 1 to 3 is set to the passband of the filter 203, thereby enabling the filter 203 to cancel the interference that the subcarrier element corresponding to the FFT output point 4 gives to the element of the subcarriers allocated to the desired user.

Referring back to FIG. 3, the channel compensator 208 calculates a weight coefficient for compensating channel distortion due to fading, by ZF (Zero Forcing), MMSE (Minimum Mean Square Error), or the like, with use of the channel estimation values received from the channel estimator 210. Then, the channel compensator 208 multiplies, by the weight coefficient, the frequency domain signals received from the FFT unit 207, to perform channel compensation. It is preferable to calculate the weight coefficient in consideration of the frequency response of the subcarriers for the filtering unit 203, as well as the channel estimation values. The frequency response for the filtering unit 203 is known to the reception device, and is reported to the channel compensator 208, thereby enabling the calculation.

The signal detector 209 extracts, from the signals output from the channel compensator 208, modulation symbols associated with the desired data signal. Then, the signal detector 209 performs a demodulation process and a decoding process to obtain the desired data signal. Additionally, the signal detector 209 outputs, to the interference canceller 205, the encoded bit LLR associated with the desired data signal.

The signal detector 209 includes: a parallel-to-serial converter 221; a demodulator 222; a deinterleaver 223; and a decoder 224. The parallel-to-serial converter 221 extracts the modulation symbols addressed to the desired user from the signals output from the channel compensator 208. Then, the parallel-to-serial converter 221 performs parallel-to-serial conversion on the extracted modulation symbols. The demodulator 222 performs a demodulation process on the modulation symbols output from the parallel-to-serial converter 221, and outputs a soft decision value (encoded bit LLR).

A process performed by the demodulator 222 is explained with a case in which the modulation symbols addressed to the desired user are QPSK modulation symbols. Explanations are given under the assumption that a QPSK symbol transmitted on the transmitting side is denoted as X, and a symbol input to the demodulator 222 on the receiving side is denoted as Xc. When b₀ and b₁ (b₀, b₁=±1) are bits included in X, X can be expressed as an expression (2), where j denotes the imaginary unit. From the estimation value Xc of X on the receiving side, λ(b₀) and λ(b₁) that are LLRs of the bits b₀ and b₁ can be calculated by the following expression (3).

$$\begin{matrix}( Expression 2 ) & \\ X = \frac{1}{\sqrt{2}} ( {b}_{0} + j {b}_{1} ) & ( 2 ) \\ ( Expression 3 ) & \\ λ ( {b}_{0} ) = \frac{2 Re ( {X}_{c} )}{\sqrt{2} ( 1 - μ )} & ( 3 )\end{matrix}$$

Here, Re( ) denotes a real part of a complex number. μ denotes equivalent amplitude after channel compensation. For example, μ=W(k)·H(k) where H(k) denotes the channel estimation value of the k-th subcarrier, and W(k) denotes the multiplied weight for the channel compensation based on the MMSE standard. λ(b₁) is calculated by replacing the real part of Xc with the imaginary part. Data having been subjected to other modulation, such as 16QAM, can be calculated based on the same principle. Additionally, the demodulator 222 may calculate a result of hard decision instead of the result of soft decision.

The deinterleaver 223 performs, on the data sequence that is the result of the soft decision by the demodulator 222, rearrangement of bits associated with the pattern for the interleaving performed by the interleaver 112-n of the transmission device 100 on the transmission source, that is, the rearrangement of bits reverse to the pattern for the interleaving.

The decoder 224 performs, on the signal output from the deinterleaver 223, an error correction decoding process associated with the error correction coding, such as turbo coding or convolutional coding, which has been performed by the transmission device 100 on the transmission source. Thereby, the decoder 224 calculates output results of soft decision, such as LLRs (Log Likelihood Ratios) of the encoded bits, and inputs the results of the soft decision for the desired user to the interference canceller 205.

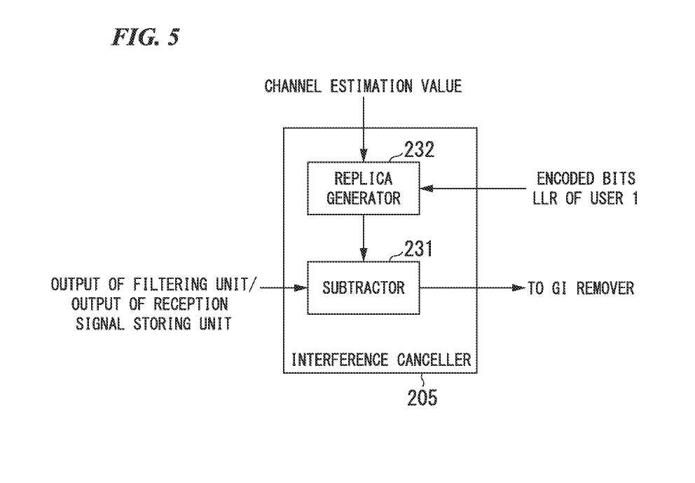

FIG. 5 is a schematic block diagram illustrating a configuration of the interference canceller 205. The interference canceller 205 includes a subtractor 231 and a replica generator 232. The replica generator 232 generates replicas of interference elements (interference replicas) using the channel estimation values and the soft decision values associated with the data signals of the desired user (LLRs of the encoded bits). Specifically, replica generator 232 generates replicas of signals that the transmission device 100, which is the transmission source of the received signal, might have transmitted to the reception device 200, using the LLRs of the encoded bits decoded which are output from the signal detector 209. In other words, the reception device 200 generates replicas of the transmission signal of the user 1 that the transmission device 100 might have transmitted. Additionally, the replica generator 232 generates interference replicas using the replicas of the transmission signals and the channel estimation values received from the channel estimator 210. The subtractor 231 subtracts the interference replicas from the signal received from the filtering unit 203 or the reception signal storing unit 204. When the signal received from the filtering unit 203 or the reception signal storing unit 204 is denoted as r(t), and the interference replica for the i-th iterative process is denoted as r̂ᵢ(t), the signal r~ᵢ(t) output from the subtractor can be expressed as the following expression (4). Here, “r̂” and “r~” indicates the letter “r” above which “̂” and “~” are added, respectively. The same applies to “ŝ,” “ĉ,” and “ĥ” that will be explained later.

(Expression 4)

\tilde{r}ᵢ(t)=r(t)−\hat{r}(t) (4)

Here, r̂ᵢ(t)=r(t) in the case of the initial process (i=0).

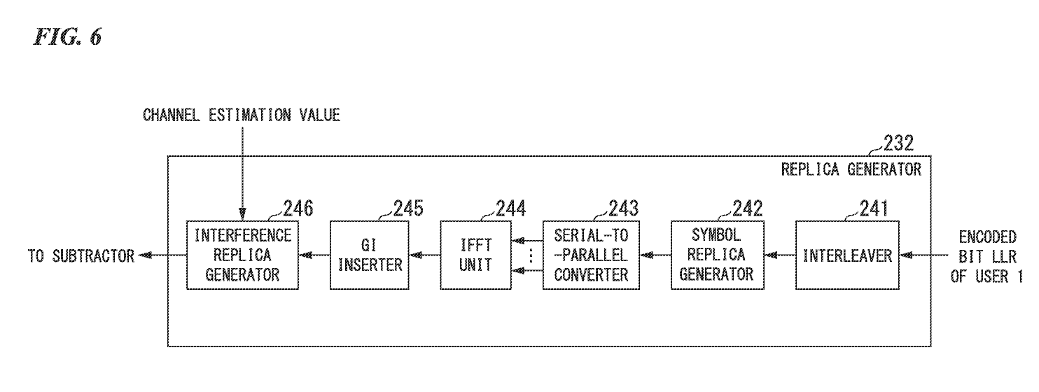

FIG. 6 is a schematic block diagram illustrating a configuration of the replica generator 232. The replica generator 232 includes: an interleaver 241; a symbol replica generator 242; a serial-to-parallel converter 243; an IFFT unit 244; a GI inserter 245; and an interference replica generator 246.

The interleaver 241 rearranges the order of the LLRs of the encoded bits decoded which are output from the signal detector 209 to the same order as that of the encoded data signals having been subjected to the data modulation performed by the transmission device 100. In other words, the interleaver 241 interleaves the LLRs of the encoded bits decoded which are output from the signal detector 209, by the same pattern of the interleaving performed by the interleaver 112-1 of the transmission device 100. In other words, the interleaver 241 performs rearrangement which is reverse to the rearrangement performed by the deinterleaver 223.

The symbol replica generator 242 generates replicas of modulation symbols (modulation symbol replicas) with respect to the signal of the desired user, using the LLRs of the encoded bits output from the interleaver 241. For example, when the modulation scheme used by the modulator 113-1 of the transmission device 100 is QPSK, the symbol replica generator 242 generates replica symbols of QPSK modulation symbols expressed by the following expression (5) where λ(b₀) and λ(b₁) denote LLRs of bits b₀ and b₁ included in the QPSK modulation symbol. The symbol replica generator 242 applies the same principle to generate modulation symbol replicas also when another modulation scheme, such as 16QAM, is used.

$$\begin{matrix}[ Expression 5 ] & \\ \frac{1}{\sqrt{2}} tanh ( λ ( {b}_{0} ) / 2 ) + \frac{j}{\sqrt{2}} tanh ( λ ( {b}_{1} ) / 2 ) & ( 5 )\end{matrix}$$

The serial-to-parallel converter 243 serial-to-parallel converts the modulation symbol replicas output from the symbol replica generator 242 based on the positions and the number of the subcarriers allocated with the modulation symbols of the user 1 on the transmitting side.

The IFFT unit 244 maps the modulation symbol replicas output from the serial-to-parallel converter 243 to the IFFT input points corresponding to the positions of the subcarriers in the received OFDMA signal, which are allocated with the modulation symbols (modulation symbols of the user 1) associated with the modulation symbol replicas. Then, the IFFT unit 244 performs an IFFT process, thereby converting the replicas of the modulation symbols of the desired user (modulation symbol replicas for the desired users) from frequency domain signals to a time domain signal. The IFFT unit 244 allocates null signals (sets zero) to the positions of subcarriers allocated with modulation symbols of non-desired users. Further, it is preferable that the IFFT unit 244 allocates pilot symbols to the IFFT input points corresponding to the positions of the subcarriers allocated with the pilot symbols that are known signals.

For example, in the case where modulation symbols of each user are allocated in the received OFDMA signal based on the user assignment shown in FIG. 2, the modulation symbol replicas output from the symbol replica generator 242 are allocated to the IFFT input points of 1 to 3. Additionally, a pilot symbol is allocated to the IFFT input point of 4.

The GI inserter 245 adds a guard interval (GI) to the time domain signal converted by the IFFT unit 244. The signal replica ŝᵢ(t) output from the GI inserter 245 can be expressed by the following expression (6).

$$\begin{matrix}[ Expression 6 ] & \\ \hat{s} ( t ) = \frac{1}{\sqrt{{N}_{f}}} {\sum }_{l = - ∞}^{∞} {\sum }_{k = 0}^{{N}_{f} - 1} {\hat{c}}_{k , l} {e}^{j k {Δ}_{f} ( t - l {T}_{s} )} & ( 6 )\end{matrix}$$

Here, ĉ_{k,l} denotes a modulation symbol of the desired user. c^{̂}_{k,l} may include a known symbol, such as a pilot symbol, which is allocated to a subcarrier within the passband of the filtering unit 203. In the case of the user assignment shown in FIG. 2, the modulation symbols c_{0,1} to c_{2,1} and the pilot symbol c_{3,1} for the user 1 are allocated to the positions of the associated subcarriers.

The interference replica generator 246 generates interference replicas of interference elements affecting the OFDMA signal received by the reception device 200, using the signal output from the GI inserter 245 and the channel estimation values. The interference elements include inter-symbol interference, inter-carrier interference, and the like. The interference replica generator 246 generates an interference replica for each interference element.

For example, when the OFDMA signal is affected by inter-symbol interference, the inter-symbol interference replica r̂ᵢ(t) (t≦Tₛ, where Tₛ denotes the OFDM symbol length) generated by the interference replica generator 246 can be expressed by the expression (7) where ŝᵢ(t) denotes the signal output from the GI inserter 245, ĥ(t) denotes a channel estimation value, ŝᵢ(t) and ĥ(t) being for the i-th iterative process performed by the interference canceller 205. In other words, the interference replica r̂ᵢ is an OFDM symbol prior to the OFDM symbol subjected to the FFT process in each delayed wave that is received by the reception device and has a delay time exceeding the GI, to which the replicas of the elements included in the OFDM symbol section for the

FFT process are added. The OFDM symbol prior to the OFDM symbol subjected to the FFT process is generated using the transmission replicas for the desired user which are generated from λᵢ₋₁ that are the LLRs of the encoded bits output from the signal detector 209 in the (i−1)-th iterative process. The aforementioned process of subtracting interference replicas is performed on each of the OFDM symbols included in a frame or packet, thereby cancelling inter-symbol interference. Similarly, a control signal for the desired user and inter-symbol interference to a pilot symbol can be cancelled.

$$\begin{matrix}[ Expression 7 ] & \\ {\hat{r}}_{i} ( t ) = {\sum }_{d} {\hat{h}}_{d} ( t ) {\hat{s}}_{i - 1} ( t - ( {τ}_{d} - {T}_{gi} ) ) & ( 7 )\end{matrix}$$

Here, r̂₀(t)=0 in the case of the initial process (i=0). ĥ_{d} denotes impulse response of the channel estimation value, which is complex amplitude of the d-th path. t denotes a time. τ_{d} denotes a delay time counted from the time the first path (preceding wave) of the d-th path (the d-th delayed wave) arrives (from the synchronization point for the FFT process). T_{gi} denotes the length of the inserted guard interval. d satisfies the condition that τ_{d}>T_{gi}.

It is preferable that the interference replicas are generated in consideration of the impulse response of the filtering unit 203 as well as the channel estimation values. The impulse response of the filtering unit 203 is known to the reception device, and is reported to the replica generator 232, thereby enabling the generation of the interference replicas. In other words, the inter-symbol replica r̂ᵢ′(t) generated by the interference replica generator 246 can be expressed by the expression (8).

[Expression 8]

\hat{r}ᵢ′(t)=g(t) [symbol] \hat{r}ᵢ(t) (8)

Here, g(t) denotes impulse response of the filtering unit.

[symbol]

[Expression 9]

denotes convolutional arithmetic.

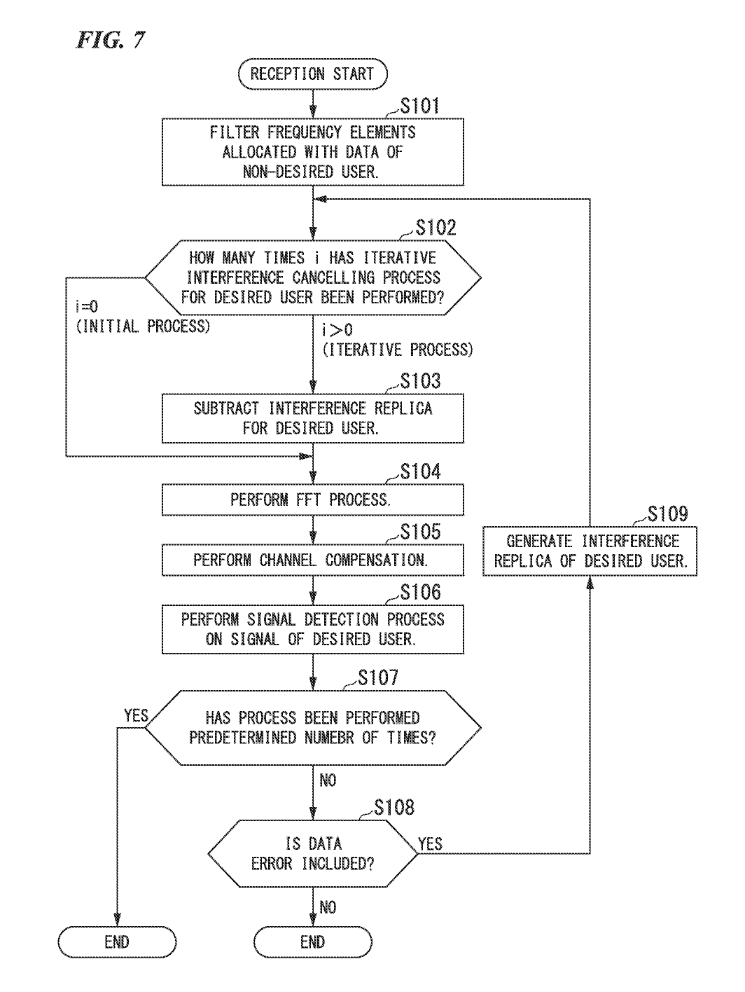

FIG. 7 is a flowchart illustrating operations of the reception device 200. Upon receiving an OFDMA signal transmitted from the transmission device 100, the filtering unit 203 of the reception device 200 filters frequency elements allocated with data signals of non-desired users to extract frequency elements allocated with the data signal of the desired user (S101). Then, the reception device 200 determines the iteration number of times in an iterative interference cancelling process performed by the interference canceller 205 (S102). In the case of the initial process (i=0), the filtering unit 203 outputs a signal including the frequency elements for the desired user, as it is. This signal is subjected to the process performed by the GI remover 206, and then input to the FFT unit 207. On the other hand, in the case of an iterative process (i>0), interference to the signal of the desired user is cancelled using the interference replicas generated from the LLRs of the encoded bits calculated in the decoding process in the (i−1)-th iterative process (S103).

Then, the FFT unit 207 performs an FFT process on the signal having been subjected to the processes in S102 and S103 (S104). Then, the channel compensator 208 performs compensation for channel distortion on the signal converted into frequency domain signals (S105). Modulation symbols of the desired user are extracted from the frequency domain signals having been subjected to the channel compensation. Then, a demodulation process and a decoding process are performed on the extracted modulation symbols (S106). If the interference cancelling process is performed the predetermined number of times (S107: YES), the process ends and the reception device 200 enters an idle state for waiting to receive the next data. On the other hand, if the interference cancelling process is not performed the predetermined number of times (S107: NO), presence or absence of errors in the data signal of the desired user is determined (S108). If there is no error, the process ends and the reception device 200 enters the idle state for waiting to receive the next data. On the other hand, if there is error, interference replicas for the desired user are generated using LLRs of the encoded bits output from the decoder 224 (S109). Then, the generated interference replicas are input to the interference canceller 205, and another interference cancelling process is performed. In other words, the interference cancelling process is iteratively performed until the process is performed the predetermined number of times or it is determined that there is no error in the data signal.

As explained above, in the first embodiment, if the transmission device 100 transmits an OFDMA signal, and the reception device 200 receives the OFDMA signal with a delay exceeding the guard interval, the reception device 200 reduces, by the time filter, frequency elements allocated with non-desired users, with respect to the signals of the non-desired users. Accordingly, the signal elements for the non-desired users can be reduced, thereby suppressing inter-symbol interference and inter-carrier interference due to the elements for the non-desired users, which are generated by the FFT process. Further, the signal elements for the non-desired users can be suppressed by the time filter. Additionally, the iterative interference cancelling, which cancels interference elements using interference replicas generated from the results of soft decision which are obtained by the decoding process, can be used for the desired user, thereby precisely suppressing inter-symbol interference and inter-carrier interference with respect to the desired user. In other words, the signal elements for the non-desired users are reduced by the time filter, thereby enabling the iterative interference cancelling, which can precisely cancel interference, to be applied to the desired user without calculating soft decision values for the non-desired users. Accordingly, even if the reception device 200 receives the OFDMA signal, in which multiple users are multiplexed under the channel environments likely to cause a long delay exceeding the guard interval, excellent reception characteristics can be obtained.

### Second Embodiment

A communication system according to a second embodiment of the present invention includes: a transmission device 300 configured to transmit an OFDMA signal, in which multiple users are assigned to OFDM subcarriers; and a reception device 400 configured to receive the signal transmitted from the transmission device 300. Hereinafter, the transmission device 300 is installed in a base station included in a cellular system. The reception device 400 is installed in one of multiple mobile terminals linked to the base station.

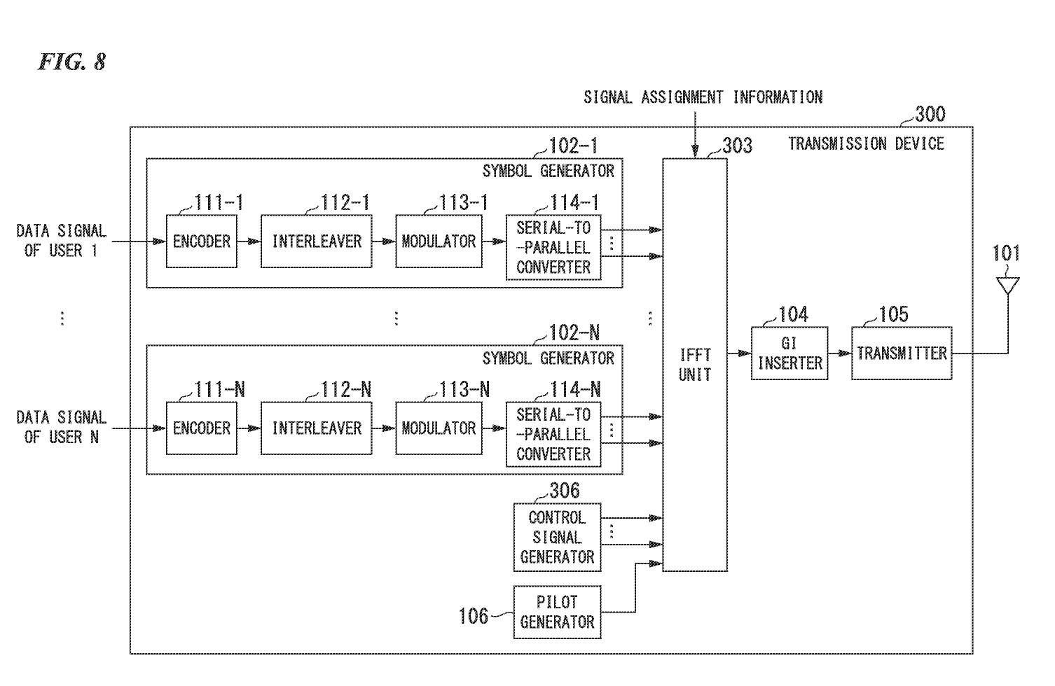

FIG. 8 is a schematic block diagram illustrating a configuration of the transmission device 300 according to the second embodiment of the present invention. The transmission device 300 includes: the symbol generators 102-1 to 102-N; an IFFT unit 303; the GI inserter 104; the transmitter 105; the pilot generator 106; and the control signal generator 306. The antenna unit 101 is connected to the transmitter 105. N denotes the number of users who can be linked to the base station installed with the transmission device 100. The same reference numerals are appended to constituent elements having similar functions to those of the transmission device 100 of the first embodiment. Hereinafter, constituent elements having different functions from those of the transmission device 100 are explained.

The control signal generator 306 generates control signals with respect to data signals of the respective users which are generated by the symbol generators 102-1 to 102-N, and inputs the generated control signals to the IFFT unit 303. The control signals are signals required for: reporting transmission signals, such as a data modulation scheme, an encoding rate, or the number of rank for MIMO (Multiple Input Multiple Output); detecting transmission signal format information, such as allocation positions of pilot signals; and detecting data signals, such as synchronization signals. Additionally, it is preferable that the control signals have been subjected to error correction coding and data modulation.

Based on the signal assignment information, the IFFT unit 303 maps to input points of the IFFT unit 303: modulation symbols of a data signal of each user which are received from the symbol generators 102-1 to 102-N; pilot symbols received from the pilot generator 106; and control signals received from the control signal generator 306. The signal assignment information is information concerning positions of subcarriers allocated with the data signal of each user, pilot symbols, and control signals.

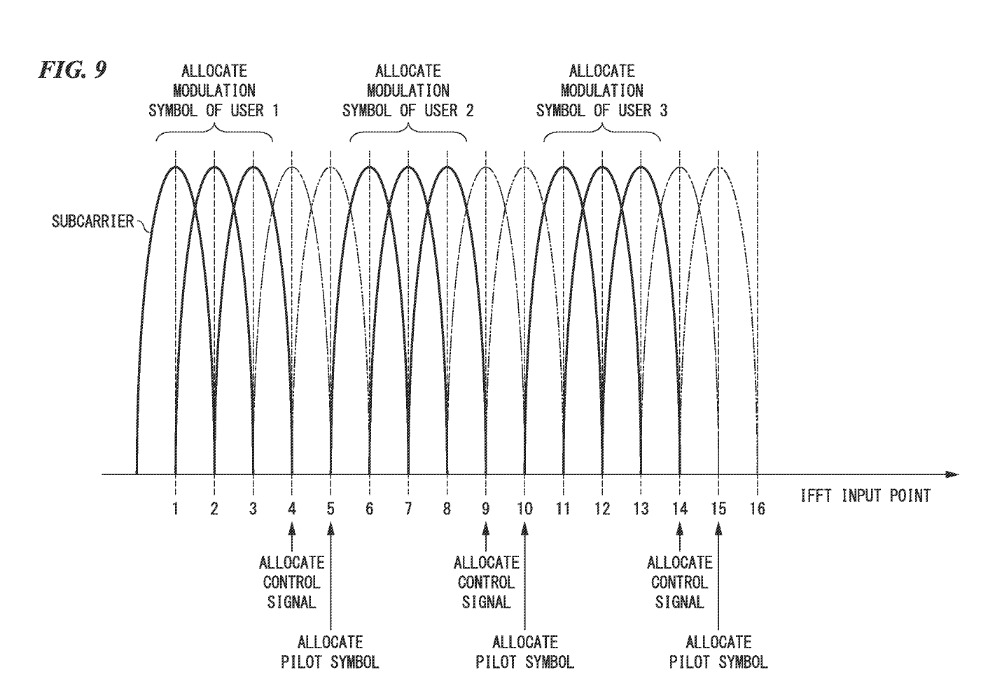

FIG. 9 illustrates an example of mapping, to the input points of the IFFT unit 303, modulation symbols, pilot symbols, and control signals for the user n, which are received from the symbol generator 102-n. FIG. 9 illustrates a case in which the number of IFFT points is 16, the number of users is 3 (N=3), three OFDMA subcarriers are assigned to each user, a pilot symbol and a control signal are mapped between two adjacent sets of the signals of the respective users. In other words, control signals are mapped to the input points 4, 9, and 14 of the IFFT unit 303. Pilot symbols are mapped to the input points 5, 10, and 15. Modulation symbols of the user 1 are mapped to the input points 1 to 3. Modulation symbols of the user 2 are mapped to the input points 6 to 8. Modulation symbols of the user 3 are mapped to the input points 11 to 13.

Although the pilot symbols and the control signals are mapped to subcarriers so as to be scattered thereover, these symbols and signals may be mapped to fixed positions of subcarriers.

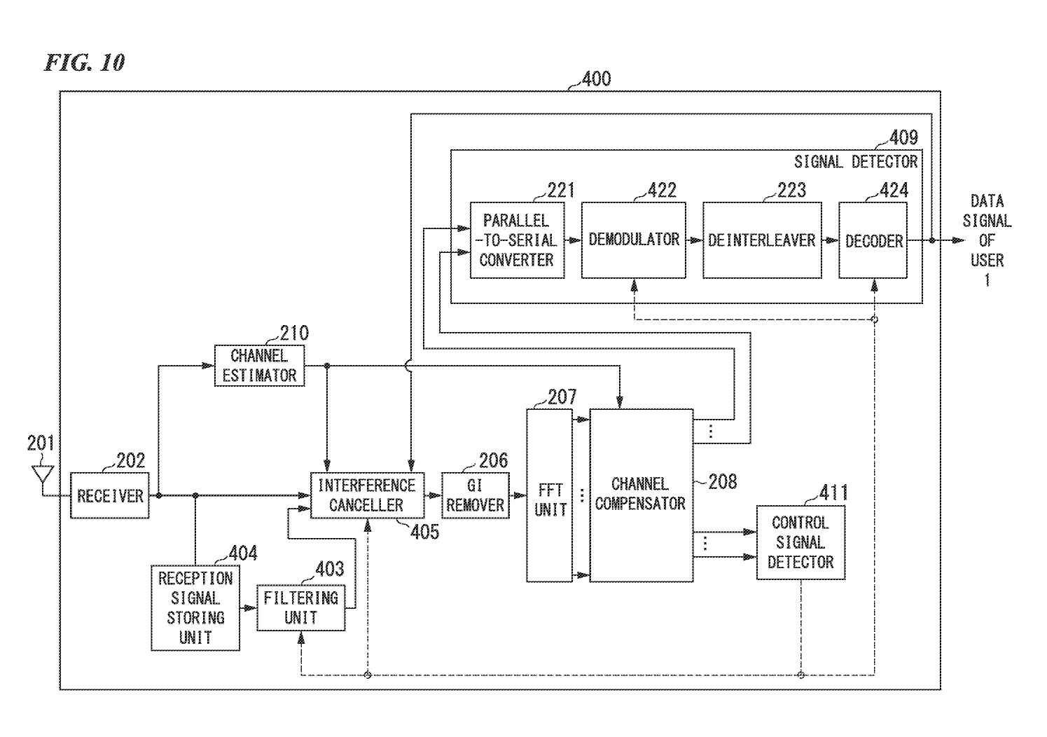

FIG. 10 is a schematic block diagram illustrating a configuration of the reception device 400 according to the second embodiment of the present invention. Explanations are given under the assumption that the reception device 400 is installed in a mobile terminal of the user 1 which receives the signal transmitted from the transmission device 300. It is possible that a reception device installed in a mobile terminal of a user n (n=1, 2, . . . , N) has at least similar functions.

The reception device 400 includes: the receiver 202; a filtering unit 403; a reception signal storing unit 404; an interference canceller 405; the GI remover 206; the FFT unit 207; the channel compensator 208; a signal detector 409; a control signal detector 411; and the channel estimator 210. The antenna unit 201 is connected to the receiver 202. The same reference numerals are appended to constituent elements having the same functions as those of the reception device 200. Hereinafter, the constituent elements having different functions from those of the reception device 200 are mainly explained.

The reception signal storing unit 404 stores a signal output from the receiver 202. Additionally, if the iterative interference cancelling process is performed, the reception signal storing unit 404 inputs the stored signal to the filtering unit 403.

Based on information concerning positions of subcarriers allocated with a signal of a desired user, which is received from the control signal detector 411, the filtering unit 403 makes a frequency band and a bandwidth variable so that frequency elements of subcarriers allocated with the signal of the desired user become a passband.

The interference canceller 405 has the same configuration as that of the interference canceller 205 of the first embodiment, but a signal input to the interference canceller 405 differs. In other words, the interference canceller 405 performs the process on the signal output from the receiver 202 in the case of the initial process (i=0). In the case of the iterative process (i>0), the interference canceller 405 performs the interference cancelling process on the signal output from the filtering unit 403. The interference canceller 405 receives information concerning the positions of subcarriers to which a data signal is mapped, which is output from the control signal detector 411. The interference canceller 405 sets subcarriers subjected to the iterative interference cancelling process with respect to the desired user, based on the information concerning the positions of the subcarriers.

The control signal detector 411 extracts, from signals which are output from the FFT unit 207 and whose channel distortion has been compensated by the channel compensator 208, symbols to which control signals are mapped. Additionally, the control signal detector 411 performs demodulation and decoding processes on the extracted symbols to obtain control information. Further, the control signal detector 411 reports, to the filtering unit 403, the obtained control information related to the positions of subcarriers to which data of the desired user are mapped. Moreover, the control signal detector 411 reports, to the signal detector 409, information related to a modulation scheme and an encoding rate for the data signal of the desired user. The control signal detector 411 may use channel estimation values calculated by the channel estimator 210 to perform a process using channel estimation values, such as channel distortion compensation.

If the reception device knows the positions of subcarriers allocated with control signals, the control signal detector 411 obtains the control signal by the aforementioned process from the signals having been subjected to the band limitation performed by the filtering unit 203 having the passband within which the positions of the subcarriers are included.

The signal detector 409 performs a signal detection process based on information related to a modulation scheme and an encoding rate for data signals of the desired user, which is received from the control signal detector 411. The signal detector 409 includes: a parallel-to-serial converter 221; a demodulator 422; a deinterleaver 223; and a decoder 424.

The demodulator 422 performs a demodulation process based on the information related to the modulation scheme for the data signals of the desired user, which is received from the control signal detector 411. Then, the demodulator 422 outputs a soft decision value (encoded bit LLR). The docoder 424 performs an error correction decoding process associated with the error correction coding, based on the information related to the encoding rate for the desired user, which is received from the control signal detector 411. Then, the decoder 424 outputs a soft decision value (encoded bit LLR) to the interference canceller 405.

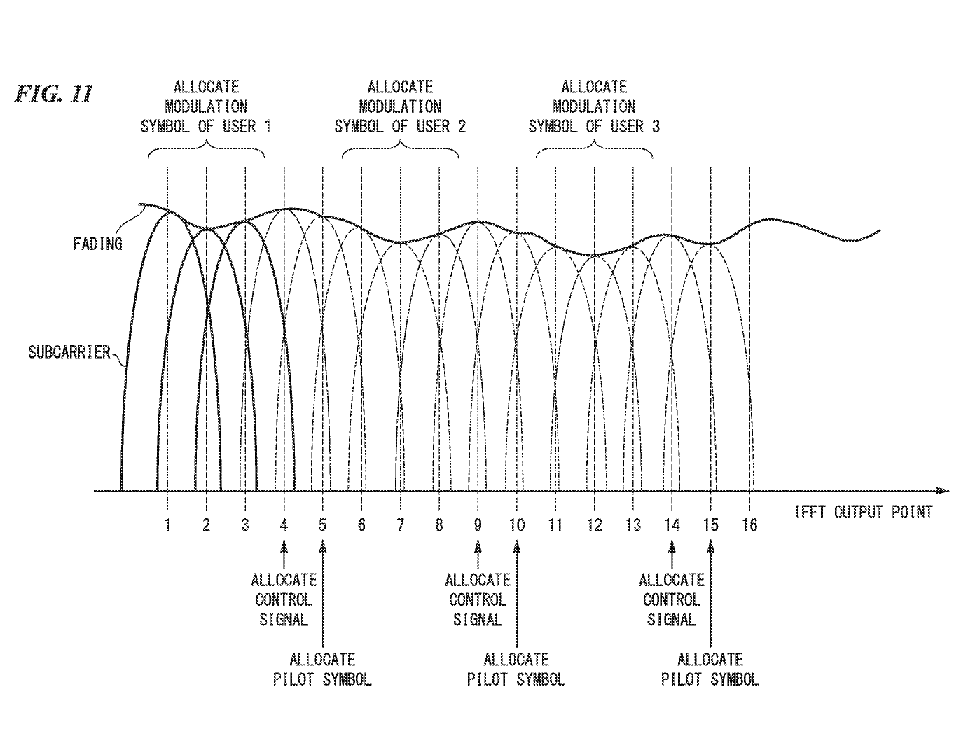

FIG. 11 is a diagram illustrating an output signal of the FFT unit 207 when the process performed by the interference canceller 405 is the initial process. In the initial process, the interference canceller 405 receives the signal from the receiver 202 and outputs signal elements of all subcarriers, which are signal elements mapped by the transmission device 300 to the respective subcarriers. The control signal detector 411 obtains, from the control signal shown in FIG. 11, information required for detecting data signal of the desired user, such as the positions of subcarriers assigned to the desired user, and modulation and encoding schemes.

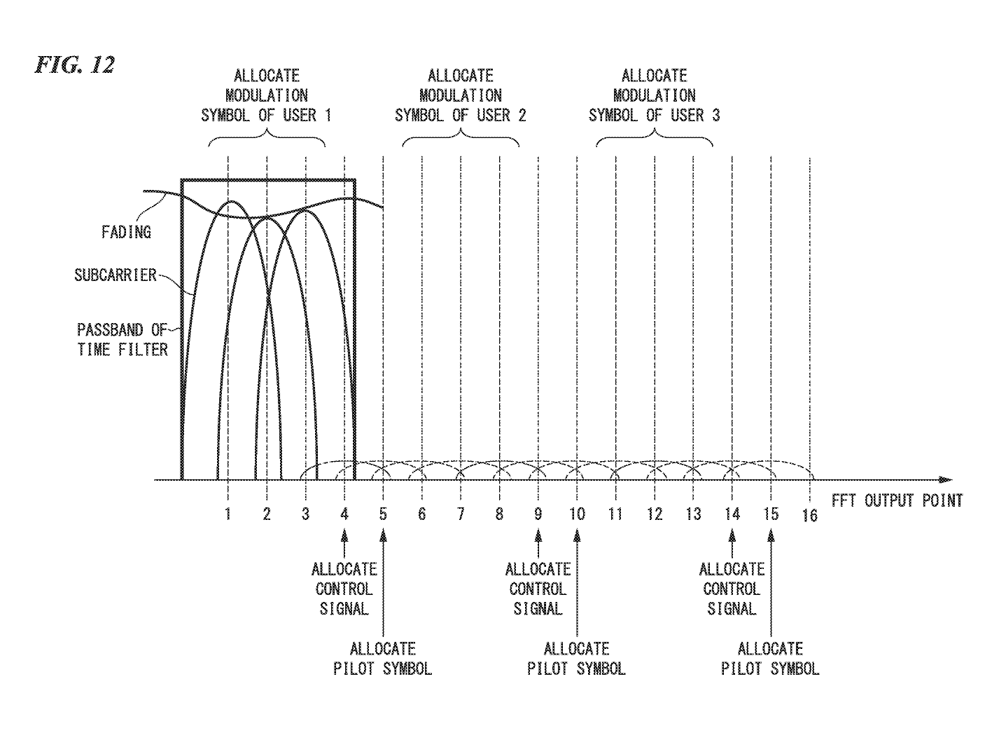

FIG. 12 is a diagram illustrating the output signal of the FFT unit 207 when the process performed by the interference canceller 405 is the iterative process. In the iterative process, the signals extracted by the filtering unit 403 based on the information concerning the positions of the subcarriers assigned to the desired user are subjected to the FFT process. For this reason, frequency elements of the subcarriers assigned to the non-desired users are suppressed. Accordingly, even if the control information concerning the desired data and the desired data are transmitted on the same OFDM symbol or in the same time slot, the information concerning the positions of the subcarriers to which the desired data are mapped can be obtained from the control information. Further, the iterative interference cancelling process can be performed on the desired user after the frequency elements for the non-desired users are suppressed.

In the case of FIG. 12, in the iterative process, frequency elements of subcarriers allocated with data of the non-desired users, frequency elements of subcarriers allocated with pilot symbols, and frequency elements of subcarriers allocated with control signals are suppressed by the time filter. However, the passband of the time filter may be set so that only the frequency elements of the subcarriers allocated with the data of the non-desired user are suppressed. It is explained in the second embodiment that the reception device performs the iterative interference cancelling process only on the data signal of the desired user. However, the aforementioned iterative cancelling process is applicable to signals that can be decoded by the reception device, such as control signals concerning the data signal of the desired user.

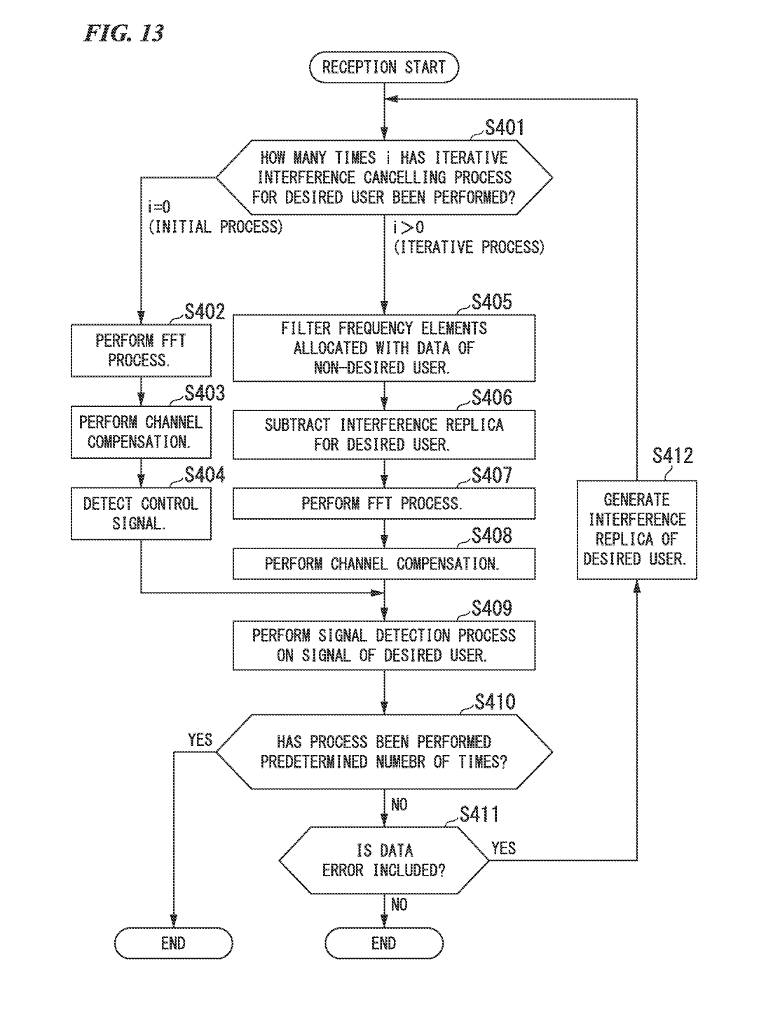

FIG. 13 is a flowchart illustrating operations of the reception device 400. Upon receiving an OFDMA signal transmitted from the transmission device 300, the reception device 400 determines the iteration number of times the interference cancelling process has been performed on the data signal of the desired user (S401). In the case of the initial process (i=0), the GI remover 206 performs the process on the signal output from the receiver 202, and then the FFT unit 207 performs the FFT process (S402). Then, the channel compensator 208 performs compensation for channel distortion on the signal converted into frequency domain signals (S403). Then, the control signal detector 411 extracts a control signal from the frequency domain signals having been subjected to the channel compensation. Thus, the control signal detector 411 obtains information related to the positions of subcarriers to which data of the desired user are mapped, and the modulation scheme and the encoding rate for the data signal of the desired user (S404). Then, the signal detector 409 performs demodulation and decoding processes based on the information related to the modulation scheme and the encoding rate for the data signal of the desired user. Thus, the signal detector 409 calculates the encoded bit LLR with respect to the data signal of the desired user (S409)

On the other hand, if it is determined in S401 that the interference cancelling is an iterative process (i>0), the output signal of the receiver 202, which is stored in the reception signal storing unit 404, is input to the filtering unit 403. Then, only frequency elements allocated with data of the desired user are extracted based on the positions of the subcarriers assigned to the desired user, which are obtained by the control signal detector 411 (S405). Then, the interference canceller 405 performs, on the signal output from the filtering unit 403, canceling of interference to the signal of the desired user, using the interference replicas generated from the encoded bit LLR calculated by the decoding process in the (i−1)-th iterative process (S406). Then, the GI remover 206 performs the process on the signal having been subjected to the interference cancelling process by the interference canceller 405. Then, the FFT unit 207 performs the FFT process on the signal output from the GI remover 206 (S407). Then, the channel compensator 208 performs compensation for channel distortion on the signal converted into frequency domain signals (S408). Then, the signal detector 409 performs demodulation and decoding processes based on the information related to the modulation scheme and the encoding rate for the data signal of the desired user. Thus, the signal detector 409 calculates encoded bit LLR for the data signal of the desired user (S409).

Then, if the interference cancelling process has been performed the predetermined number of times (S410: YES), the process ends and the reception device enters an idle state for waiting to receive the next data. On the other hand, if the interference cancelling process has not been performed the predetermined number of times (S410: NO), the reception device determines presence or absence of errors in the data signal of the desired user (S411). If there is no error (S411: NO), the process ends and the reception device enters an idle state for waiting to receive the next data. If there is error (S411: YES), interference replicas for the desired user are generated using the encoded bit LLRs output from the decoder 424 (S412). Then, the generated interference replicas are input to the interference canceller 405, and another interference cancelling process is performed.

As explained above, in the second embodiment, if the transmission device 300 transmits an OFDMA signal, and the reception device 400 receives the OFDMA signal with a long delay exceeding a guard interval, the reception device 400 reduces, by the time filter, frequency elements assigned to non-desired users, with respect to the signals of the non-desired users. Accordingly, signal elements for the non-desired users are suppressed, thereby reducing inter-symbol interference and inter-carrier interference due to the elements for the non-desired users which are generated by the FFT process. Further, the signal elements for the non-desired users can be suppressed by the time filter. Additionally, the iterative interference cancelling, which cancels interference elements using the interference replicas generated from the results of soft decision obtained by the decoding process, can be used, thereby precisely reducing inter-symbol interference and inter-carrier interference with respect to the desired user. Moreover, the reception device 400 of the second embodiment uses, only in the iterative process, the time filter that reduces signal elements for the non-desired users. For this reason, even if a control signal with respect to a data signal of the non-desired user and the control signal are transmitted in the same slot, the data signal of the desired user can be detected. The band of the time filter is set based on the control signal. For this reason, even if the control signal with respect to the data signal and the data signal are transmitted in the same time slot, the iterative interference cancelling process can be applied to the desired user.

It has been explained in the aforementioned first and second embodiments that the present invention is applied to the OFDMA in which signals of multiple users are allocated to OFDM subcarriers. However, the present invention is not limited thereto. The present invention is applicable to a communication system that transmits a signal in which multiple users are multiplexed using orthogonalized frequencies, based on MC-CDMA (Multi Carrier-Code Division Multiple Access), SC-FDMA (Single Carrier-Frequency Division Multiple Access), DFT-S-OFDMA (Discrete Fourier Transform-Spread-OFDMA), and the like.

### INDUSTRIAL APPLICABILITY

The present invention is applicable to a multicarrier wireless communication field.

### DESCRIPTION OF REFERENCE NUMERALS

100 and 300: transmission device

101: antenna unit

102-1 to 102-N: symbol generator

103 and 303: IFFT unit

104: GI inserter

105: transmitter

106: pilot generator

200 and 400: reception device

201: antenna unit

202: receiver

203 and 403: filtering unit

204 and 404: reception signal storing unit

205 and 405: interference canceller

206: GI remover

207: FFT unit

208: channel compensator

209 and 409: signal detector

210: channel estimator

231: subtractor

232: replica generator

306: control signal generator

411: control signal detector

1-9. (canceled)

10. A reception device comprising:
a filtering unit configured to receive a signal in which a plurality of users are multiplexed using a plurality of orthogonalized frequencies, and perform a filtering process in a time domain so as to reduce a signal element for a non-desired user from the signal received.

11. The reception device according to claim 10, further comprising:
an FFT unit configured to convert the signal received by the filtering unit, which is a time-domain signal, into a plurality of frequency-domain signals,
wherein the FFT unit has a first frequency bandwidth, and
the filtering unit has a second frequency bandwidth smaller than the first frequency bandwidth.

12. The reception device according to claim 10, further comprising:
a receiver configured to receive the signal in which the plurality of users are multiplexed using the plurality of orthogonalized frequencies;
a filtering unit configured to perform the filtering process in the time domain so as to reduce the signal element for the non-desired user from the signal received by the receiver;
an interference canceller configured to cancel, from the signal having been subjected to the filtering process, an interference element generated using a result of a decoding process performed on the signal having been subjected to the filtering process by the filtering unit;
a signal detector configured to perform a decoding process on the signal output from the interference canceller and outputs a result of the decoding process,
wherein the process performed by the interference canceller and the process performed by the signal detector are iteratively performed until a predetermined condition is satisfied,
the interference canceller is configured to output, for a first time of the iteration, one of the signal having been subjected to the filtering process and the signal received by the receiver without generating and cancelling the interference element, and
the interference canceller is configured to generate, for a second time or more, an interference element using a result of the decoding process for the previous time.

13. The reception device according to claim 12, further comprising:
a control signal detector configured to detect, from a control signal included in the signal received by the receiver, a position of a subcarrier to which a data signal of a desired user is mapped.

14. The reception device according to claim 13, wherein the interference canceller is configured to perform an interference cancelling process based on the position of the subcarrier.

15. The reception device according to claim 13, wherein the filtering unit is configured to set a band for the filtering process based on the position of the subcarrier.

16. The reception device according to claim 12, wherein
the signal detector is configured to perform an error correction decoding process and output a soft decision value, and
the reception device further comprises:
a replica generator configured to generate an interference replica using the soft decision value output from the signal detector; and
a subtractor configured to subtract the interference replica from the signal having been subjected to the filtering process by the filtering unit.

17. A receiving method comprising:
a first step of receiving a signal in which a plurality of users are multiplexed using a plurality of orthogonalized frequencies;
a second step of performing a filtering process in a time domain so as to reduce a signal element for a non-desired user from the signal received in the first step;
a third step of cancelling, from the signal having been subjected to the filtering process, an interference element generated using a result of a decoding process performed on the signal having been subjected to the filtering process by the filtering unit; and
a fourth step of performing a decoding process on the signal output from the interference canceller and outputting a result of the decoding process,
wherein the process in the third step and the process in the fourth step are iteratively performed until a predetermined condition is satisfied,
the third step comprises:
outputting, for a first time of the iteration, one of the signal having been subjected to the filtering process and the signal received by the receiver without generating and cancelling the interference element; and
generating, for a second time or more, an interference element using a result of the decoding process for the previous time.

18. A communication system comprising:
a transmission device configured to transmit a signal in which a plurality of users are multiplexed using a plurality of orthogonalized frequencies; and
a reception device configured to receive and decode the signal transmitted from the transmission device,
wherein the reception device comprises:
a receiver configured to receive the signal transmitted;
a filtering unit configured to perform a filtering process in a time domain so as to reduce a signal element for a non-desired user from the signal received by the receiver;
an interference canceller configured to cancel, from the signal having been subjected to the filtering process, an interference element generated using a result of a decoding process performed on the signal having been subjected to the filtering process by the filtering unit; and
a signal detector configured to perform a decoding process on the signal output from the interference canceller and outputs a result of the decoding process,
wherein the process performed by the interference canceller and the process performed by the signal detector are iteratively performed until a predetermined condition is satisfied,
the interference canceller is configured to output, for a first time of the iteration, one of the signal having been subjected to the filtering process and the signal received by the receiver without generating and cancelling the interference element, and
the interference canceller is configured to generate, for a second time or more, an interference element using a result of the decoding process for the previous time.

19. A communication method comprising:
a process of transmitting signal in which a plurality of users are multiplexed using a plurality of orthogonalized frequencies; and
a process of receiving and decoding the signal transmitted from the transmission device,
wherein the process of receiving and decoding the signal comprises:
a first step of receiving the signal transmitted;
a second step of performing a filtering process in a time domain so as to reduce a signal element for a non-desired user from the signal received in the first step;
a third step of cancelling, from the signal having been subjected to the filtering process, an interference element generated using a result of a decoding process performed on the signal having been subjected to the filtering process by the filtering unit; and
a fourth step of performing a decoding process on the signal output from the interference canceller and outputting a result of the decoding process,
wherein the process in the third step and the process in the fourth step are iteratively performed until a predetermined condition is satisfied,
the third step comprises:
outputting, for a first time of the iteration, one of the signal having been subjected to the filtering process and the signal received by the receiver without generating and cancelling the interference element; and
generating, for a second time or more, an interference element using a result of the decoding process for the previous time.
